(19) United States
(12) Patent Application Publication
(10) Pub. No.: US 2003/0236992 A1
(43) Pub. Date: Dec. 25, 2003

(54) Method and system for providing secure logging for intrusion detection

(76) Inventor: Sameer Yami, Santa Clara, CA (US)

Correspondence Address: WAGNER, MURABITO & HAO LLP, Third Floor, Two North Market Street, San Jose, CA, 95113, US

(21) Appl. No.: 10/176,196

(22) Filed: Jun. 19, 2002

(51) Int. Cl. H04L 9/00

(52) U.S. Cl. 713/200

(57) ABSTRACT

A method and system for providing secure logging for intrusion detection is disclosed. The method and system provides for receiving log data, writing information to a log file based on the log data received, writing a first line to a log file as a signature, obtaining a random symmetric key during the writing of a second line, generating a MAC (message authentication code) for the first line from the random symmetric key, and generating a respective key during the writing of each subsequent line and utilizing the respective key to generate a MAC for the line previous to the subsequent line. In addition, the method and system provides for the writing of a last line to the log file to comprise a signature.

### TECHNICAL FIELD

The present invention relates generally to computer software systems. In particular, an embodiment of the invention relates to a method and system for providing secure logging of information generated by computer software systems.

### BACKGROUND ART

Log files are widely used in software applications to record information about events that occur during the lifetime of the software. These records allow the administrator of the software to verify its normal functioning as well gather information regarding anomalies that are reported. Thus, the recording of information about a software event provides a record of the state of the software system over a period of time. This observation is based on the assumption that for a particular software system, events are logged by different components of the software at different points in time.

In situations where a software system is hacked by a malicious user, the identity of the hacker is traceable because log files maintain event related information that provides evidence of the intrusion. Hackers therefore delete log records from the log files to remove evidence of their intrusion.

Algorithms and systems are available which detect such changes in the log files (deletion and modification of the log records). One such system provides logs that are written with the help of interaction with a trusted machine over a secure channel. A feature of this system is that each log entry is encrypted with a key that is derived from the logging components authentication key. Also, each log entry has its own permission mask for limiting access during verification in the case of role based security. This system, however, is extremely complicated, computationally expensive, assumes unlimited storage space for audit files, and relies on the continuous presence of a secure connection to the remote trusted machine. Moreover, it does not provide a remedy for situations where the hacker/intruder is an internal malfeasant. For instance, in such situations, the hacker/intruder can simply log into the machine (which requires no remote connection) and cause damage without detection. In addition, it should be appreciated that dependency on remote sources to provide system configurations may prove inadequate because some configurations are best left to the actual auditors (as opposed to remote sources) since an auditor presumably knows his or her system best.

In other logging schemes, log entries are simply written with the appropriate MACs (message authentication codes) appended to the end of the log entry. However, the keys of the MACs are derived not only from the previous keys but also using the newly generated log data. This dependency on data generation prevents the verification of the logs at multiple intrusion points. Also, there is no appropriate role separation for configuring or viewing the logs. It should be noted that this particular implementation does not detail out the overall architecture of the audit log security, the security of the secret keys generated, or the security of auditable events occurring during system crash/failure etc.

### SUMMARY OF THE INVENTION

Accordingly, a need exists for a method and system which provides secure logging for intrusion detection, that features a separation of aspects of the logging and verification functions, and may be implemented on a single machine. Embodiments of the present invention provide a method and system which accomplishes the above mentioned need.

For instance, one embodiment of the present invention provides a method and system for providing secure logging for intrusion detection. The method and system provides for receiving log data, writing information to a log file based on the log data received, writing a first line to a log file as a signature, obtaining a random symmetric key during the writing of a second line, generating a MAC (message authentication code) for the first line from the random symmetric key, and generating a respective key during the writing of each subsequent line and utilizing the respective key to generate a MAC for the line previous to the subsequent line. In addition, the method and system provides for the writing of a last line to the log file to comprise a signature.

In one embodiment, a separate log verifier generates a hash of previous log files and compares the generated hash with the signature in the first line in order to verify the authenticity of the signature. The separate verifier can run independently of the system administrator based on a periodic duty cycle. In such case, malfeasance of the system administrator can be detected by the verifier.

In yet another embodiment, the present invention includes a computer-usable medium having computer-readable code embodied therein for causing a computer to perform particular actions. As described above to provide secure logging for intrusion detection.

These and other advantages of the present invention will no doubt become obvious to those of ordinary skill in the art after having read the following detailed description of the preferred embodiments which are illustrated in the drawing figures.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1A shows modules of a secure logging system for intrusion detection according to one embodiment of the present invention.

FIG. 1B is a functional block diagram illustrating the operation of components of the secure logging system according to one embodiment of the present invention.

FIG. 2 is a flowchart of steps performed by the logger according to one embodiment of the present invention.

FIG. 3 is a flowchart of a logging protocol accompanying the process of writing information to a log file according to one embodiment of the present invention.

FIG. 4 shows a flowchart of the steps performed in generating keys and MACs (message authentication codes) according to one embodiment of the present invention.

FIG. 5 is a schematic illustrating an exemplary log file assemblage process according to one embodiment of the present invention.

FIG. 6 is a flowchart of steps performed by the verifier in accordance with one embodiment of the present invention.

FIG. 7 is a block diagram of an embodiment of an exemplary computer system used in accordance with one embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

### Notation and Nomenclature

Some portions of the detailed descriptions which follow are presented in terms of procedures, logic blocks, processing, and other symbolic representations of operations on data bits within a computer system or electronic computing device. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system or similar electronic computing device. For reasons of convenience, and with reference to common usage, these signals are referred to as bits, values, elements, symbols, characters, terms, numbers, or the like with reference to the present invention.

It should be borne in mind, however, that all of these terms are to be interpreted as referencing physical manipulations and quantities and are merely convenient labels and are to be interpreted further in view of terms commonly used in the art. Unless specifically stated otherwise as apparent from the following discussions, it is understood that throughout discussions of the present invention, discussions utilizing terms such as “generating” or “modifying” or “retrieving” or the like, refer to the action and processes of a computer system, or similar electronic computing device, that manipulates and transforms data. For example, the data is represented as physical (electronic) quantities within the computer system's registers and memories and is transformed into other data similarly represented as physical quantities within the computer system memories or registers or other such information storage, transmission, or display devices.

### Secure Logging for Intrusion Detection

The method and system of the present invention provide for the secure logging of information used for intrusion detection. According to exemplary embodiments of the present invention, the system may be implemented on a single machine having multiple users. According to such embodiments, any anomalies in the log files may be detected whether they involve log file or log file line deletions, modifications, or other types of changes. According to one embodiment, the system can detect which lines of the log file have been modified or deleted based on the current contents of the file.

One embodiment of the present invention provides a computer implemented verifier that operates as a separate thread along with the logger. Further, according to exemplary embodiments of the present invention, the verifier can function independently of the system administrator and may, according to such embodiments, operate to detect file tampering by an intruder including the system administrator itself. It should be appreciated that an auditor may be authorized to configure certain aspects of the verifiers automatic operation, such as when the verifier is to be invoked.

Exemplary embodiments of the present invention use string data to generate authentication codes. According to one embodiment, a MAC (message authentication codes) is generated using a combination of string and key data. The first key used may be generated by a crypto module and stored in secure storage after its initial use. According to one embodiment, the MAC generated is used by the verifier to detect whether or not there has been a system intrusion.

### Exemplary System in Accordance with Embodiments of the Present Invention

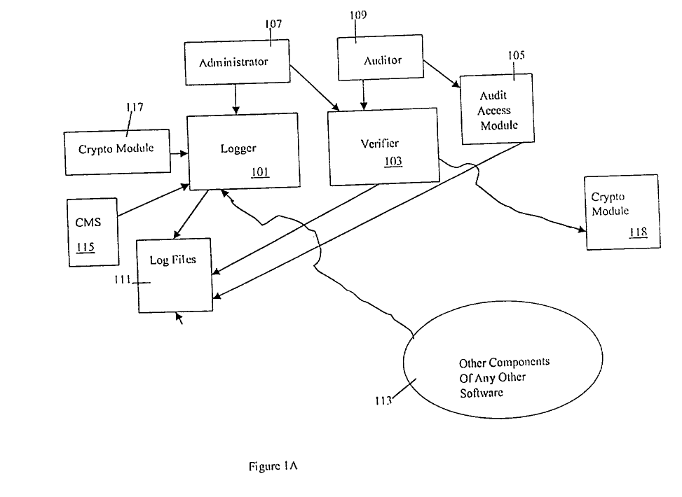

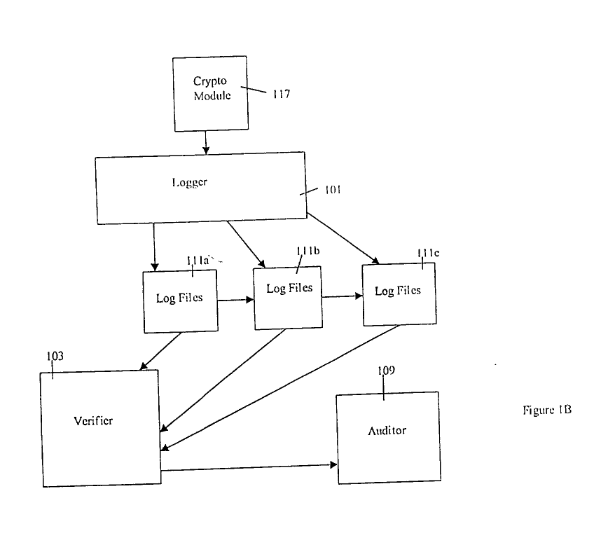

FIG. 1A shows a secure logging system 100 for intrusion detection according to one embodiment of the present invention. Referring to FIG. 1A, there is shown logger 101, verifier 103, administrator 107, auditor 109, log files 111, other components 113, audit access module 105, CMS (certificate management system) 115, crypto-module 117 and crypto-module 118.

The logger 101 logs information about events that occur during the lifetime of a software system. The logger 101 is responsible for writing the logged information to log files 111. According to one embodiment, the logger 101 may be invoked by all modules/services (e.g., other components 113) performing functions on behalf of the system 100. Also, according to one embodiment, these modules/services may be authenticated using standard authentication procedures (e.g., login identification and password) that may include but are not limited to a CMS (certificate management system) 115. Such procedures enable authenticated modules/services (e.g., other components 113) to log information to the logger 101. According to exemplary embodiments, the recording of events and/or fields may be configurable. These configurations may be modified or deleted at any time. Also, according to exemplary embodiments, the logging of information may be triggered by the initiation of the event to be logged. According to one embodiment, the information logged may include an indication of the logged events terminations, thereby providing a more detailed description of the entire event logged.

The verifier 103 verifies and audits the information logged by the logger 101. It is responsible for reading and verifying the contents of the log file 111. According to one embodiment, it may also be responsible for notifying the auditor (e.g., 109) and/or triggering a callback function, if an intrusion is detected.

The audit access module 105 is responsible for accessing and displaying data to the auditor 109 in the format that is required by the auditor. According to one embodiment, the auditor 109 may constitute special software provided functionalities. According to such embodiments, the auditor 109 may possess the exclusive authorization to view existing log files and to delete older log files. According to one embodiment, the auditor 109 may always be authenticated to the logging system 100 using standard authentication procedures. These procedures may include but are not limited to password based, LDAP (lightweight directory access protocol), or certificate based schemes. Additionally, the audit access module 105 may be responsible for sorting and searching data, and may provide a mechanism which facilitates the setting of values for the logger 101 (administrator only), and for the verifier 103 (auditor only).

The system administrator 107 may configure the logger 101. According to one embodiment, this configuration determines the events and parameters that are to be logged. According to exemplary embodiments, the system administrator 107 sets values for the logger 101 that include but are not limited to values such as the time period taken for a new key to be encrypted, the number of files allowed before a new file is created, and the disk space threshold that triggers the logging of auditor generated logging information only.

Log files 111 record information about events that happen during the lifetime of software. As previously mentioned, according to one embodiment, the information recorded may be determined by the system administrator 107. These records facilitate the verification by the verifier 103 of the normal functioning of the software as well as the detection of system intruders (e.g., the detection of any unauthorized deletion or modification of the log file 111). The information that is written to the log files 111 is provided by the logger 101.

Crypto module 117 generates a random symmetric key that is used to derive subsequent line keys and MACs (message authentication codes). The crypto module 117 communicates the random symmetric key to the logger 101. Verifier 103 may have a separate crypto-module 118. Crypto modules 117 and 118 are first initialized by the administrator 107 with initial keys. Thereafter, crypto module 118 is re-initialized by the auditor with his/her own password to prevent subsequent access to crypto module 118 by the system administrator. The administrator 107 retains access to crypto module 117.

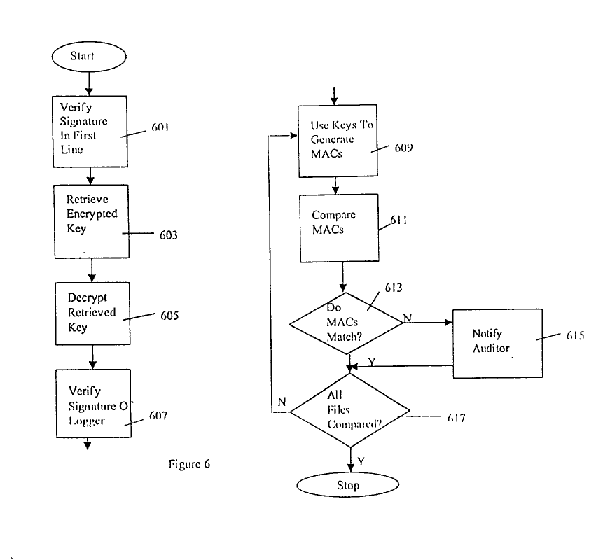

FIG. 1B is a functional block diagram illustrating the operation of components described with reference to FIG. 1A. Referring to FIG. 1B, according to one embodiment, the crypto module 117 generates a random symmetric key k0 which is communicated to the logger 101. The logger uses this information along with a log data string (see FIG. 1B) supplied by other components (e.g.,113) to create log files 111a-111c. These log files can be read periodically by the verifier 103 which then verifies the logged information therein in accordance with processes described herein with reference to FIG. 6. If anomalies are found in the subject log file (e.g. 111) the auditor (e.g.109) may be notified. According to one embodiment, the verifier may, upon detecting anomalies in a log file, trigger operations that include but are not limited to, the sending of an e-mail message, the generation of a pop up alert or the cessation of certificate issuance (authentication).

### Exemplary Operations in Accordance with Embodiments of the Present Invention

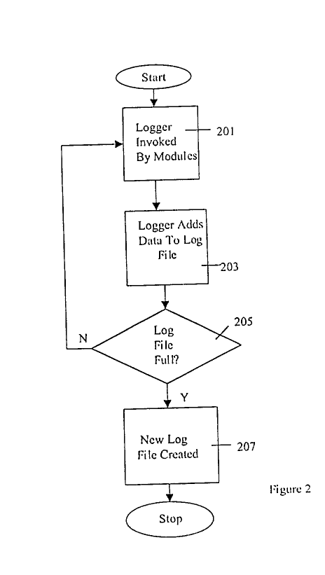

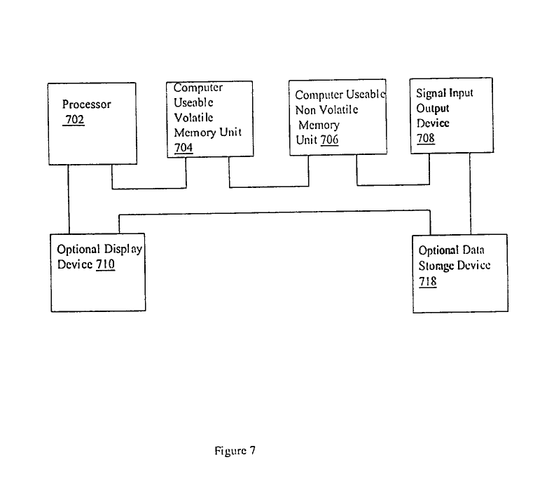

FIGS. 2-4, and 6 are flowcharts of computer implemented steps performed in accordance with one embodiment of the present invention for providing a secure logging scheme for intrusion detection. The flowcharts include processes of the present invention which, in one embodiment, are carried out by processors and electrical components under the control of computer readable and computer executable instructions. The computer readable and computer executable instructions reside, for example, in data storage features such as computer usable volatile memory and/or computer usable non-volatile memory (e.g. 704 and 706 described herein with reference to FIG. 7). However, the computer readable and computer executable instructions may reside in any type of computer readable medium. Although specific steps are disclosed in the flowcharts, such steps are exemplary. That is, the present invention is well suited to performing various other steps or variations of the steps recited in FIGS. 2-4, and 6. Within the present embodiment, it should be appreciated that the steps of the flowcharts may be performed by software, by hardware or by any combination of software and hardware.

Logger

FIG. 2 is a flowchart of the steps performed by a logger according to one embodiment of the present invention. Referring to FIG. 2, at step 201, a logger (e.g.,101) is invoked by a module that provides some function on behalf of a system (e.g., 100). As mentioned previously, these modules/services may be authenticated using some standard authenticating procedure (certificates etc.) that allows them to log information to the logger. According to one embodiment, the recording of events may be configurable and may be modified or deleted at any time. Also, according to exemplary embodiments, the logging of information may begin with the start of an event and may also indicate the end of an event to provide better information about the entire event.

At step 203, the logger adds data to a log file (e.g., 111). Data here refers to all possible auditable actions, the user identification, or any other data that is relevant. Also, according to one embodiment, a timestamp may be generated from a reliable time stamping source. According to one embodiment, the logger may add data to the nth line of the log file in the following XML or similar format:

Line n: <Timestamp></Timestamp><Data><MAC(Timestamp, Data, MAC of Line n−1, Key Related Data)>

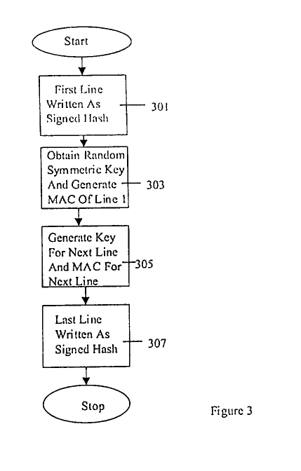

In alternate embodiments, individual fields may be added utilizing an Extended File Format. It should be noted that according to exemplary embodiments, the first line written to each log file includes the signed hash of previous log files, while the last line written to each log file includes the signed hash of previous and current log files. The steps performed in writing to a log file will be described herein with reference to FIG. 3 below.

At step 205, it is determined whether or not the log file is full. If the log file is full then control is passed to step 207 where a new log file is created. If the log file is not full, control returns to step 201 and the logger may add data to the current log file when invoked by modules/services (see steps 201 and 203).

At step 207, the logger creates a new log file (with the date/time as its suffix for enabling differentiation) after the current file reaches a predetermined size or when the signing event is due—whichever is appropriate (according to one embodiment this may be configurable by the system administrator). The signing event is configurable and provides for the periodic signing of the logs. According to exemplary embodiments, the old file is signed by the logger and archived. According to one embodiment, where a new log file is not created and only the current log is signed, a separate log entry may be made in accordance with a format that includes a signed hash of the current and previous log files (see discussion made with reference to FIG. 3, step 307 below).

FIG. 3 is a flowchart 300 of a logging protocol accompanying the process of writing information to a log file (e.g., 111) according to one embodiment of the present invention. Due to its readily verifiable form (see discussion made with reference to FIG. 6 below), the protocol employed facilitates the detection of any modification or deletion of the log file.

Referring to FIG. 3, step 301, according to one embodiment, the first line of the log file (e.g., 111) is written as the signed hash of all previous files (e.g., Sign Logger Private Key (Hash (Previous Log Files)). For instance, if the previous log files are log 1 and log 2, and the current log file is log 3, then according to such embodiments, the following steps may be taken to write the first line: (a) retrieve the signature (hash (log 1+log 2)) from secure storage, (b) verify the retrieved signature (configurable in the verifier and hence may not be performed), and (c) write the signature to the first line of log 3 as <signature>signature</signature>.

At step 303, a random symmetric key k0 is generated by the crypto module during the writing of the second line. According to one embodiment, this random symmetric key is used to generate the MAC (message authentication code) of line 1.

At step 305, a key is generated during the writing of the line 3 using the random symmetric key generated in step 303. This key, k1, is computed based on the previous key k0, by k1=MAC(k0). According to one embodiment the generated key is used to create a MAC for the next line (line 2). This step is repeated for subsequent lines (a key is generated that is used to generate the MAC of the previous line) until the number of lines that are written in the log file reaches a value determined by the system administrator (e.g., 107).

At step 307, a signature is written to the last line of the log file. According to one embodiment this signature includes the signed hash of all previous and current log files (e.g., Signature Logger Private Key (hash of all previous files+hash of current log file)). According to one embodiment this signature, which may be called the relay signature, may be stored in a secure storage location overwriting any previously stored relay signature.

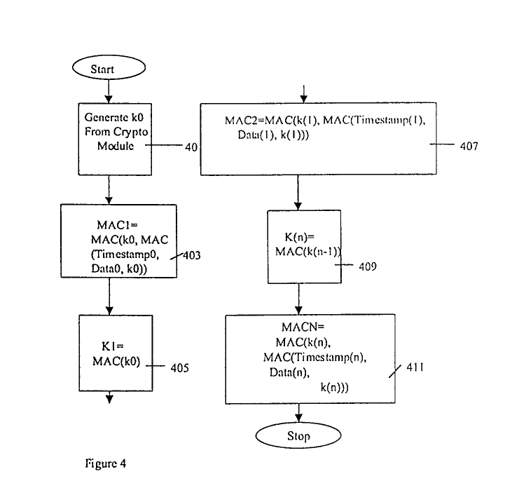

FIG. 4 shows a flowchart of the steps performed in generating keys and MACs according to one embodiment of the present invention. Referring to FIG. 4 at step 401, during the writing of the second line of a log file (e.g., 111) a random symmetric “h” key is obtained from crypto module 117 or is securely generated (e.g., a secure random number). From this key the MAC of line 1 is generated at step 403 using the equation:

MAC1=MAC(k0, MAC(Timestamp0, Data0, k0)).

At step 405, for the third line, a new key is generated using the equation:

k1=MAC(k0).

It should be appreciated that random symmetric key k0 generated in step 401 is used to generate k1. According to one embodiment, the random symmetric key k0 is then signed with the private key of the logger (assuming a separate private/public key pair has been issued by the Certificate Authority), encrypted with the public key of the verifier, and placed in a secure location (e.g., a keystore). Typically, the random symmetric key is not used again by the logger. In alternate embodiments, the key may be stored in any secure storage and is available only to the verifier at some later point in time. According to such embodiments, not even the logger (e.g., 101) uses the key. According to one embodiment, the key is saved against the same name as the log file for easy future retrieval. This is done to facilitate the generation of a new random symmetric key k0 for a future log file.

At step 407, the MAC of line2 is generated using the equation:

MAC2=MAC(k(1), MAC(Timestamp(1), Data(1), k(1))).

At step 409, for the nth line, k(n) is calculated as:

k(n)=MAC(k(n−1)).

And, at step 411, the MAC of the nth line is calculated as:

MAC=MAC(k(n), MAC(TimeStamp(n), Data(n), k(n))).

Every time a key k is generated, it is maintained securely until the next key kn+1 is generated. This is useful in cases where lines are deleted from log files (e.g., 111) that have not yet been signed and additional logs are not being generated. If log lines are modified or deleted in between the signing of the first and last line of a log file, then the verifier will detect anomalies as is discussed below with reference to FIG. 6. However, where log lines at the end of a log file are concerned a different process may be employed. For example, if lines n to n+5 located at the end of a log file are deleted, according to exemplary embodiments, the verifier will calculate keys for each log file line (e.g., lines 1 to n−1) still present after the deletion, beginning with the key k for line 1. According to such embodiments, the verifier (e.g., 103) will then compare the key generated for the last line present after the deletion (kₙ₋₁) with that of the last key maintained in secure store (kₙ₊₅) Since the key kₙ₊₅ corresponding to the last line written before deletion (line n+5) exists in the secure store, and does not match the verifier generated key kₙ₋₁ corresponding to the last line still present after the deletion (line n−1), a system intrusion is detected.

It should be appreciated that, according to exemplary embodiments, the log files (e.g., 111) created by the above noted processes can be written to a separate directory where the auditor has exclusive read and write authorization. According to such embodiments, no other user has the right to access these files. In alternate embodiments, the data written to the log files may be encrypted with an additional symmetric key. The encryption may be performed in a secure crypto module and may be performed on demand or in accordance with a configurable time period. According to one embodiment, the symmetric key may be pre calculated when the logger (e.g. 101) initializes and then maintained in secure storage. In alternate embodiments, the log records may be logged and written to an LDAP server before being written to the actual log file. It should be noted that the data writing period of the above noted embodiments may be configurable. The crypto module may supply a new key upon a new log being created or at any other prescribed time.

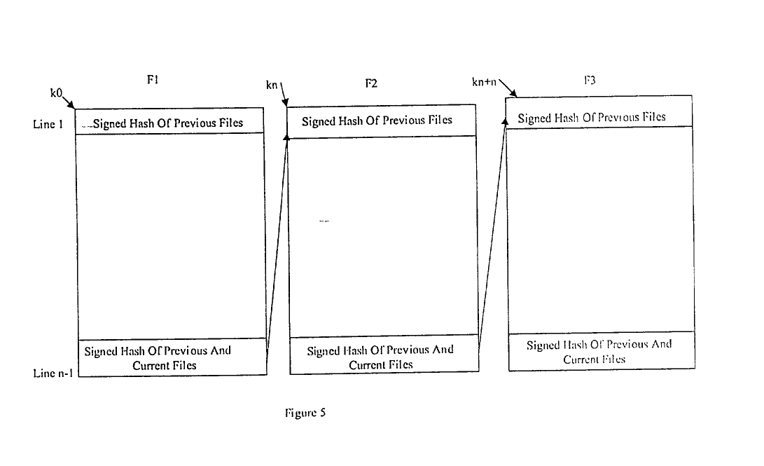

FIG. 5 is a schematic illustrating a log file assemblage process according to one embodiment of the present invention. Referring to FIG. 5 there is shown log files F1, F2 and F3. Each log file has a similar structure. As previously mentioned with reference to FIGS. 2-4, the first line of each log file includes the signed hash of all previous log files. The last line (e.g., line n−1 in FIG. 5) written to each log file includes the signed hash of the previous and the current log files. Random symmetric key k0 is used to derive the MAC of each line written to the files (through the generation of line keys such as kₙ and kₙ₊ₙ shown in FIG. 5) as was discussed above with reference to FIG. 4. The number of lines written to the files is determined by the system administrator (the limit is configurable). Also, at some configurable event in time, the auditor may delete all the old log files that have been archived and trigger the generation of a new key.

Verifier

FIG. 6 is a flowchart 600 of steps performed by a verifier (e.g. 103) in accordance with one embodiment of the present invention. The verifier's responsibility is to verify that the log files (e.g.,111) are not maliciously modified and to inform the auditor if such is the case. It runs as a separate thread alongside the logger (e.g., 101). According to one embodiment, the verifier is solely authorized to read the log file and may verify two kinds of files: (a) log files that are currently being used, and (b) log files that were created earlier and are now archived. In essence, according to one embodiment, the verifier functions to recreate the log files based on information stored therein to detect any unauthorized additions, deletions, or modifications thereto.

Referring to FIG. 6, at step 601, the verifier (e.g., 103) verifies the signature in the first line of the log file in question. This is done by first generating the hash of the previous log files and comparing this hash with the signature present in the first line of the file. For example, if a log file “k” is missing, then its generated hash will not match the signed hash present in the first line of the (k+1)th file, and its absence may be thereby detected. It should be appreciated that this process can be executed to detect any form of log file deletion. According to one embodiment, due to its expense, this particular process may be configured and activated only on the auditor's request.

At step 603, the encrypted key k0 for the log file in question is retrieved from the secure storage location (e.g., keystore etc.), and at step 605, decrypted with the private key of the verifier. At step 607, the signature of the logger (e.g., 101) is verified by the verifier.

At step 609, the MAC of different lines are generated using the key retrieved in step 603. At step 611, the MACs generated in step 609 are compared with the MACs of the log file in question.

At step 613, if it is determined that the MACs generated in step 609 and the MACs of the log file in question match then nothing is done. However, if it is determined that they do not match, the auditor (e.g., 109) is notified at step 615 of the anomaly identified and the line where it was found is specified. After the auditor is notified, the process is repeated so that other anomalies in the log file may be identified.

At step 617, if all MACs of the log file lines have been subjected to comparison with the verifier generated MACs of its lines, then the verification process is completed. If not, the process is repeated so that other anomalies in the log file may be identified and the auditor notified of those anomalies. It should be appreciated that when the verifier verifies log files that were created earlier and that are presently archived, the Inclusion of the signature of the previous log files in the first line of the archived log file will ensure that any accidental or deliberate deletion of any previous log file will be detected.

The above described process can be made more efficient by choosing optimum values for log file size and verification periodicity. As specified before these parameters may be configurable by the auditors, according to exemplary embodiments. The verifier can also be made to verify the older file every time the auditor logs into the system and gives special instructions to verify older log files. Moreover, special instructions from the auditor should direct the comparing of log files from the two systems (current file and previous log files). This is to ensure that even the administrator of the current system has not tampered with the log files.

### Exemplary Hardware in Accordance with Embodiments of the Present Invention

FIG. 7 is a block diagram of an embodiment of an exemplary computer system 700 used in accordance with the present invention. It should be appreciated that system 700 is not strictly limited to be a computer system. As such, system 700 of the present embodiment is well suited to be any type of computing device (e.g., server computer, portable computing device, embedded computer system, etc.). Within the following discussions of the present invention, certain processes and steps are discussed that are realized, in one embodiment, as a series of instructions (e.g., software program) that reside within computer readable memory units of computer system 700 and executed by a processor(s) of system 700. When executed, the instructions cause computer 700 to perform specific actions and exhibit specific behavior which is described in detail below.

Computer system 700 of FIG. 7 comprises an address/data bus 710 for communicating information, one or more central processors 702 coupled with bus 710 for processing information and instructions. Central processor unit 702 may be a microprocessor or any other type of processor. The computer 700 also includes data storage features such as a computer usable volatile memory unit 704 (e.g., random access memory, static RAM, dynamic RAM, etc.) coupled with bus 710 for storing information and instructions for central processor(s) 702, a computer usable non-volatile memory unit 706 (e.g., read only memory, programmable ROM, flash memory, EPROM, EEPROM, etc.) coupled with bus 710 for storing static information and instructions for processor(s) 702. System 700 also includes one or more signal generating and receiving devices 708 coupled with bus 710 for enabling system 700 to interface with other electronic devices. The communication interface(s) 708 of the present embodiment may include wired and/or wireless communication technology. For example, in one embodiment of the present invention, the communication interface 808 is a serial communication port, but could also alternatively be any of a number of well known communication standards and protocols, e.g., Universal Serial Bus (USB), Ethernet, FireWire (IEEE 1394), parallel, small computer system interface (SCSI), infrared (IR) communication, Bluetooth wireless communication, broadband, and the like.

Optionally, computer system 700 can include an alphanumeric input device 714 including alphanumeric and function keys coupled to the bus 710 for communicating information and command selections to the central processor(s) 702. The computer 700 can include an optional cursor control or cursor directing device 716 coupled to the bus 710 for communicating user input information and command selections to the central processor(s) 702. The system 700 can also include a computer usable mass data storage device 718 such as a magnetic or optical disk and disk drive (e.g., hard drive or floppy diskette) coupled with bus 710 for storing information and instructions. An optional display device 712 is coupled to bus 710 of system 700 for displaying video and/or graphics.

As noted above with reference to exemplary embodiments thereof, the present invention provides secure logging for intrusion detection. The method and system provides for receiving log data, writing information to a log file based on the log data received, writing a first line to a log file as a signature, obtaining a random symmetric key during the writing of a second line, generating a MAC (message authentication code) for the first line from the random symmetric key, and generating a respective key during the writing of each subsequent line and utilizing the respective key to generate a MAC for the subsequent line. In addition, the method and system provides for the writing of a last line to the log file to comprise a signature.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A computer controlled method of maintaining secure logging for intrusion detection comprising:
receiving log data;
writing information to a log file based on the log data received;
writing a first line to the log file to comprise a signature;
obtaining a random symmetric key during the writing of a second line;
generating a MAC (message authentication code) for the second line from the random symmetric key;
generating a respective key during the writing of each subsequent line and utilizing the key to generate a MAC for the subsequent line; and
writing a last line to the log file to comprise a signature.

2. The method of claim 1, wherein a signature written in the first line of the log file comprises a hash of previous log files.

3. The method of claim 1, wherein the last line written to the log file comprises a signed hash of all previous and current log files.

4. The method of claim 1, wherein the random symmetric key is encrypted and kept in secure storage after a subsequent key is generated.

5. The method of claim 4, wherein the random symmetric key is not used again by a logger.

6. The method of claim 5, wherein the random symmetric key is retrieved by a verifier and decrypted with a private key of the verifier.

7. The method of claim 6, wherein the verifier generates a hash of previous log files and compares the generated hash with the signature present in the first line of the log file.

8. The method of claim 7, wherein a signature of the logger is verified by comparing the generated hash.

9. The method of claim 8, wherein the random symmetric key is used by the verifier to recreate MACs of log file lines.

10. The method of claim 9, wherein the verifier determines whether verifier recreated MACs of log file lines match the MACs of lines actually present in the log file.

11. The method of claim 10, wherein an auditor is notified if verifier recreated MACs of log file lines do not match the MACs of lines actually present in the log files.

12. A computer useable medium having computer useable code embodied therein for causing a computer to perform operations comprising:
receiving log data;
writing information to a log file based on the log data received;
writing a first line to a log file to comprise a signature;
obtaining a random symmetric key during the writing of a second line;
generating a MAC (message authentication code) for the second line from the random symmetric key;
generating a respective key during the writing of each subsequent line and utilizing the respective key to generate a MAC for the subsequent line; and
writing a last line to the log file to comprise a signature.

13. The medium of claim 12, wherein a signature written in the first line of the log file comprises a hash of previous log files.

14. The medium of claim 12, wherein the last line written to the log file comprises a signed hash of all previous and current log files.

15. The medium of claim 12, wherein the random symmetric key is encrypted and kept in secure storage after a subsequent key is generated.

16. The medium of claim 15, wherein the random symmetric is not used again by a logger.

17. The medium of claim 16, wherein the random symmetric key is retrieved by the verifier and decrypted with a private key of the verifier.

18. The medium of claim 17, wherein the verifier generates a hash of previous log files and compares the generated hash with the signature present in the first line of the log file.

19. The medium of claim 18, wherein a signature of the logger is verified by comparing the generated hash.

20. The medium of claim 19, wherein the random symmetric key is used by the verifier to recreate MACs of log file lines.

21. The medium of claim 20, wherein the verifier determines whether verifier recreated MACs of log file lines match the MACs of lines actually present in the log file.

22. The medium of claim 21, wherein an auditor is notified if verifier recreated MACs of log file lines do not match the MACs of lines actually present in the log files.

23. A computer system comprising:
a bus;
a computer readable memory unit connected to said bus;
a processor coupled to said bus said processor for executing a method for implementing an application comprising the steps of:
receiving log data;
writing information to a log file based on the log data received;
writing a first line to the log file to comprise a signature;
obtaining a random symmetric key during the writing of a second line;
generating a MAC (message authentication code) for the second line from the random symmetric key;
generating a respective key during the writing of each subsequent line and utilizing the respective key to generate a MAC the subsequent line; and
writing a last line to the log file to comprise a signature.

24. The system of claim 23, wherein a signature written in the first line of the log file contains a hash of previous log files.

25. The system of claim 23, wherein the last line written to the log file comprises a signed hash of all previous and current log files.

26. The system of claim 23, wherein the random symmetric key is encrypted and kept in secure storage after a subsequent key is generated.

27. The system of claim 26, wherein the random symmetric is not used again by a logger.

28. The system of claim 27, wherein the random symmetric key is retrieved by the verifier and decrypted with a private key of the verifier.

29. The system of claim 28, wherein the verifier generates a hash of previous log files and compares the generated hash with the signature present in the first line of the log file.

30. The system of claim 29, wherein a signature of the logger is verified by comparing the generated hash.

31. The system of claim 30, wherein the random symmetric key is used by the verifier to recreate the MACs of log file lines.

32. The system of claim 31, wherein the verifier determines whether verifier recreated MACs of log file lines match the MACs of lines actually present in the log file.

33. The system of claim 32, wherein an auditor is notified if verifier recreated MACs of log file lines do not match the MACs of lines actually present in the log files.
